(19) United States
(12) Patent Application Publication
(10) Pub. No.: US 2016/0086288 A1
(43) Pub. Date: Mar. 24, 2016

(54) BUDGET TRACKING SYSTEM

(71) Applicants: Mark J. ITRI, (US); Regina Marie BARBA, (US); Duane Neal BERGMAN, Chicago, IL (US); Norman Scott STRONG, Washington, DC (US); Carol Milbourne WILL, (US); Nick Shengkuo CHEN, Washington, DC (US)

(72) Inventors: Mark J. ITRI, Newport Beach, CA (US); Regina Marie BARBA, Los Angeles, CA (US); Duane Neal BERGMAN, Inverness, IL (US); Norman Scott STRONG, Sterling, VA (US); Carol Milbourne WILL, Reston, VA (US); Nick Shengkuo CHEN, Herndon, VA (US)

(21) Appl. No.: 14/888,694

(22) PCT Filed: May 2, 2014
(86) PCT No.: PCT/US2014/036705

§ 371 Date: Nov. 2, 2015

Related U.S. Application Data
(60) Provisional application No. 61/819,437, filed on May 3, 2013.

(51) Int. Cl. G06Q 40/00

(52) U.S. Cl. CPC G06Q 40/12

(57) ABSTRACT

Tracking costs relative to a budget includes receiving one or more cost values for applying against a predefined budget, and comparing the one or more cost values against preset threshold percentages for the predefined budget, each preset threshold percentage indicating a percentage of costs applied against the predefined budget at which to notify users. Based on the comparison, a determination is made whether the one or more cost values meet or exceed at least one of the preset threshold percentages. In a case where the one or more cost values meet or exceed at least one of the preset threshold percentages, a notification is generated for a first user who bills against the predefined budget and for a second user who supervises the predefined budget, the notification indicating which of the preset threshold percentages are met or exceeded by the one or more cost values. The generated notification is provided to the first user and to the second user.

### CROSS-REFERENCE TO RELATED APPLICATION

The present application claims the benefit of U.S. Provisional Patent Application Ser. No. 61/819,437, entitled “Budget Tracking System,” filed on May 3, 2013, the contents of which are hereby incorporated by reference in its entirety for all purposes.

### BACKGROUND

The present disclosure generally relates to budget tracking systems and, in particular, to a system for creating, managing and tracking budgets for client matters.

Businesses such as service providers (e.g., law firms, accounting firms, construction companies) can enter into service agreements with clients (e.g., corporations, individuals). The agreement can define a type of service to be performed by the business and for the client. The agreement further sets a budget for that service or project.

### SUMMARY

The subject disclosure provides for a system that tracks costs relative to an established budget. Examples of costs include, but are not limited to, timekeeper costs (e.g., time spent multiplied by rate for timekeeper), vendor costs and costs for materials or other resources. Further, the costs can correspond to billed costs or work in process (WIP). The subject system can track costs, such as timekeeper costs and vendor costs, as they are entered (e.g., via respective a time entry system and third party system tracking materials), and can compare the entered costs against predefined budgets. The system can further generate specialized alerts for sending to a billing supervisor (or employees delegated by the billing supervisor), or to other stakeholders (e.g., clients). The alerts are based on actual costs (previously billed, WIP and/or vendor costs) relative to the budget. Alerts can also be sent to individual timekeepers, to notify those timekeepers when their entered time has reached predefined thresholds (e.g., 65%, 80% or 100%) relative to the budget. In addition, the system can provide a matter tracking interface which provides a financial summary and a history of alerts.

The disclosed subject matter relates to a system for tracking costs relative to a budget, the system comprising one or more processors, and a machine-readable medium comprising instructions stored therein, which when executed by the processors, cause the processors to perform operations comprising receiving one or more cost values for applying against a predefined budget. The operations further comprise comparing the one or more cost values against preset threshold percentages for the predefined budget, each preset threshold percentage indicating a percentage of costs applied against the predefined budget at which to notify users, and determining, based on the comparison, whether the one or more cost values meet or exceed at least one of the preset threshold percentages. The operations further comprise generating, in a case where the one or more cost values meet or exceed at least one of the preset threshold percentages, a notification for a first user who bills against the predefined budget and for a second user who supervises the predefined budget, the notification indicating which of the preset threshold percentages are met or exceeded by the one or more cost values, and providing the generated notification to the first user and to the second user.

The disclosed subject matter further relates to a machine-readable medium comprising instructions stored therein, which when executed by a machine, cause the machine to perform operations comprising receiving one or more cost values for applying against a predefined budget. The operations further comprise comparing the one or more cost values against preset threshold percentages for the predefined budget, each preset threshold percentage indicating a percentage of costs applied against the predefined budget at which to notify users, and determining, based on the comparison, whether the one or more cost values meet or exceed at least one of the preset threshold percentages. The operations further comprise generating, in a case where the one or more cost values meet or exceed at least one of the preset threshold percentages, a notification for a first user who bills against the predefined budget and for a second user who supervises the predefined budget, the notification indicating which of the preset threshold percentages are met or exceeded by the one or more cost values, and providing the generated notification to the first user and to the second user.

The disclosed subject matter further relates to a method for tracking costs relative to a budget. The method comprises receiving one or more cost values for applying against a predefined budget, and comparing the one or more cost values against preset threshold percentages for the predefined budget, each preset threshold percentage indicating a percentage of costs applied against the predefined budget at which to notify users. The method further comprises determining, based on the comparison, whether the one or more cost values meet or exceed at least one of the preset threshold percentages, generating, in a case where the one or more cost values meet or exceed at least one of the preset threshold percentages, a notification for a first user who bills against the predefined budget and for a second user who supervises the predefined budget, the notification indicating which of the preset threshold percentages are met or exceeded by the one or more cost values, and providing the generated notification to the first user and to the second user.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

For purpose of explanation, several embodiments of the subject technology are set forth in the following figures.

FIG. 1 illustrates an example computing architecture which provides for tracking budget for a matter.

FIG. 2 illustrates an example user interface, for multi-level activity budget and tracking, in which a task code is added to a phase code.

FIG. 3 illustrates an example user interface, for multi-level activity budget and tracking, in which an activity is added to a budget.

FIG. 4 illustrates an example user interface which displays a summary of defined phase codes.

FIG. 5 illustrates an example user interface for creating a new a budget template.

FIG. 6 illustrates an example user interface for entering task and phase codes for a budget template.

FIG. 7 illustrates an example user interface for overriding parameters or configuration options within a budget template, for a particular client matter.

FIG. 8 illustrates an example user interface for displaying a summary of budget templates.

FIG. 9 illustrates an example user interface for displaying all matters being tracked by a budget template.

FIG. 10 illustrates an example user interface for displaying all matters being tracked by a budget.

FIG. 11 illustrates an example user interface for a billing supervisor to delegate responsibility to others for managing and viewing budget information on behalf of the billing supervisor.

FIG. 12 illustrates an example user interface of a matter detail screen with consolidated information pertaining to a client matter being tracked.

FIG. 13 illustrates an example of an email notification including alert thresholds surpassed for client matters for a billing supervisor.

FIG. 14 illustrates an example of an email notification including alert thresholds surpassed for client matters for a timekeeper.

FIG. 15 illustrates an example user interface displaying a historical summary of generated alerts.

FIG. 16 illustrates an example user interface of an error message, within a time entry system, indicating that budget has been exceeded.

FIG. 17 illustrates an example user interface displaying an alert analysis for timekeepers.

FIG. 18 illustrates an example email message providing an update of budget tracking status to a client.

FIG. 19 illustrates an example email notification providing an alert to a client that budget has been exceeded.

FIG. 20 illustrates an example process by which costs are tracked relative to a budget.

FIG. 21 conceptually illustrates an example electronic system with which some implementations of the subject technology can be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

As noted above, businesses such as service providers (e.g., law firms, accounting firms, construction companies) can enter into service agreements with clients (e.g., corporations, individuals). The agreement can define a type of service to be performed by the business and for the client. The agreement further sets a budget for that service or project. To stay on budget, the business should monitor the time spent by employees, employee rates, and the resources used to provide the service.

The subject disclosure provides for a system that tracks costs relative to an established budget. Examples of costs include, but are not limited to, timekeeper costs (e.g., time spent multiplied by rate for timekeeper), vendor costs and costs for materials or other resources. Further, the costs can correspond to billed costs or work in progress (WIP). The subject system can track costs, such as timekeeper costs and vendor costs, as they are entered (e.g., via respective a time entry system and third party system tracking materials), and can compare the entered costs (e.g., including costs to be billed and previously billed) against predefined budgets. The system can further generate specialized alerts for sending to a billing supervisor (or employees delegated by the billing supervisor), or to other stakeholders (e.g., clients). The alerts are based on actual costs (e.g., including costs to be billed and previously billed) relative to the budget. Alerts can also be sent to individual timekeepers, to notify those timekeepers when their entered time has reached predefined thresholds (e.g., 65%, 80% or 100%) relative to the budget. In addition, the system can provide a matter tracking interface which provides financial summary and a history of alerts.

### I. System Overview

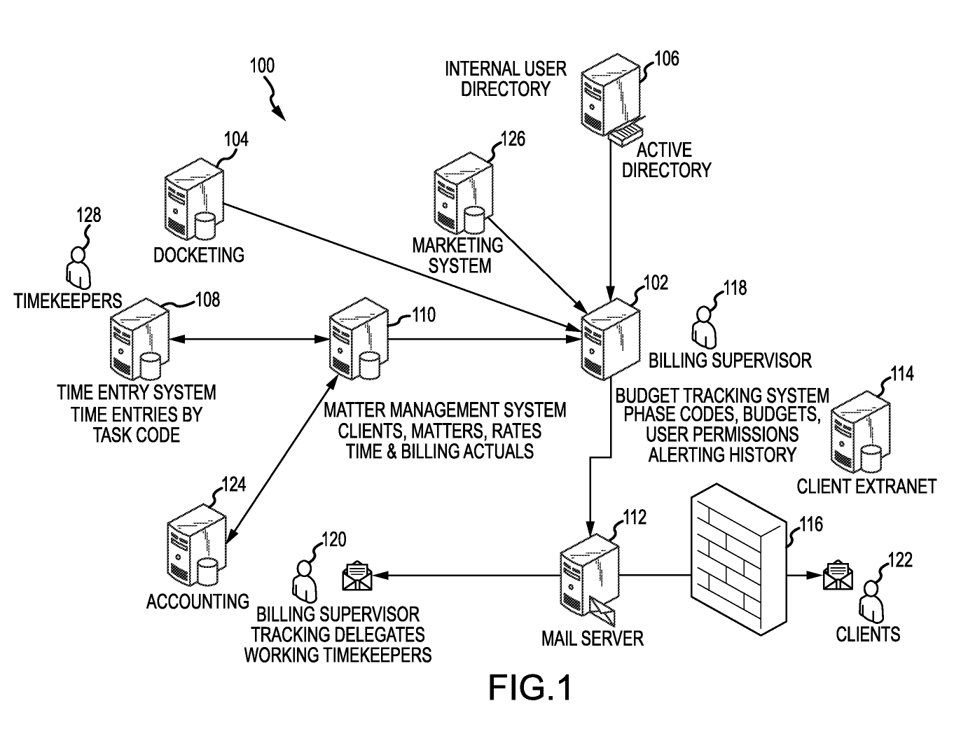

FIG. 1 illustrates an example computing architecture which provides for tracking budget for a matter. Computing architecture 100 includes a budget tracking system 102. In the example of FIG. 1, budget tracking system 102 communicates with a docketing system 104, an internal user directory system 106, a mail server 112 (e.g., an exchange server), and a matter management system 110, for example, via one or more networks. Matter management system 110 also communicates with a time entry system 108 and an accounting system 124 via a network connection.

Docketing system 104 tracks the status of work being provided, and provides for the management of a service provider's docket, which is a collection of matters handled by the service provider. For example, docketing system 104 may be used to create new matters, to schedule deadlines for tasks pertaining to each matter, and to track the progress or status of work by the service provider towards meeting the scheduled tasks.

Marketing system 126 provides for marketing services of a service provider to clients (e.g., to existing clients or to potential clients). For example, marketing system 126 can be used to send marketing communications (e.g., emails or other correspondence) to advertise existing services or new services (e.g., via email or other communication) provided by the service provider.

Internal user directory 106 provides a directory of employees within the service provider organization. For example, the directory can include names and contact information (e.g., phone numbers, email addresses) for each of the employees, including but not limited to timekeepers, billing supervisors and delegates of billing supervisors.

Time entry system 108 provides for the entry and capture of time by timekeepers (e.g., timekeeper 128). Timekeepers 128 include, but are not limited to, employees within the service provider organization with a billing rate. Using a law firm as a non-limiting example, a timekeeper can correspond to a paralegal, associate, or partner assigned to a matter, as well as to other overhead costs such as starting costs. The timekeeper 128 can interface with time entry system 108 (e.g., via a computing device such as a personal computer or mobile device) to enter time for that matter, and can provide the entered time to matter management system 110.

Matter management system 110 provides for organizing and storing the client matters for a service provider. For example, matter management system 110 stores records for each client, and all matters associated with each client. Matter management system 110 also stores records for the billing rates for each timekeeper (e.g., assistant, associate or partner).

Matter management system 110 communicates with time entry system 108, to receive time entries entered by a timekeeper via time entry system 108. Matter management system 110 can apply these received time entries to client matters, in order to calculate and store actual time values for each of the client matters. Furthermore, matter management system 110 can apply the stored actual time values to the stored billing rates for the timekeeper, in order to determine and store actual billing values. The clients, matters, rates, actual time values, and actual time values can be stored within one or more databases for matter management system 110.

For example, timekeeper A with a billing rate of $50/hour enters, via time entry system 108, a first time entry of 4 hours for client matter X. Matter management system 110 receives the entry, stores the 4 hours for timekeeper A in association with client matter X, and calculates and stores $200 of costs for timekeeper A in association with client matter X. Timekeeper B with a billing rate of $100/hour then enters, via time entry system 108, a second time entry of 4 hours for client matter X. Matter management system 110 receives the entry, stores the 4 hours for timekeeper B in association with client matter X, and calculates and stores $400 of costs for timekeeper B in association with client matter X. Matter management system 110 can calculate and store a total of $600 of costs towards client matter X, while retaining individual data records for each of the time entries by timekeepers A and B.

Matter management system 110 can provide for real-time (or substantially real-time) updates of time entry received from time entry system 108. As such, matter management system 110 can calculate and store actual costs (e.g., costs to be billed and previously billed costs) as time is entered by timekeepers. As discussed in greater detail below, the actual costs can be compared against defined budgets within matter management system 110. For example [timekeeper rate]×[timekeeper time] can equal an actual cost, which can be compared against a budget.

Matter management system 110 also communicates with accounting system 124, to receive cost information (e.g., cost of resources and materials, costs associated with third party vendors, etc). Matter management system 110 can apply this cost information to determine actual cost values for storage in one or more databases of matter management system 110.

It should be noted that communication between the systems in computing architecture 100 (e.g., systems 102, 104, 106, 108, 110, 112, 114, 124, 126) is not limited to the configuration shown in FIG. 1. For example, it is possible for budget tracking system 102 to communicate directly with time entry system 108 and with accounting system 124. Further, budget tracking system 102 can maintain and store all appropriate data records, instead of using a separate matter management system 110. In this regard, while each of the systems in computing architecture 100 is depicted as a separate system, it is possible that these systems are integrated into a common server or a group of servers.

Each of the systems in computing architecture 100 may be any system or device having a processor, a memory, and communications capability for providing content to other computing systems. In some example aspects, each system in computing architecture 100 can be a single computing device, for example, a computer server. In other embodiments, each system in computing architecture 100 can represent more than one computing device working together to perform the actions of a server computer (e.g., cloud computing). Further, each system in computing architecture 100 can represent various forms of servers including, but not limited to a web server, an application server, a proxy server, a network server, or a server farm.

In some aspects, computing architecture 100 can be a distributed client/server system that spans one or more networks. The one or more networks can correspond to a large computer network, for example, a local area network (LAN), wide area network (WAN), the Internet, a cellular network, or a combination thereof connecting any number of mobile clients, fixed clients, and servers. Further, the one or more networks can include, but are not limited to, any one or more of the following network topologies, including a bus network, a star network, a ring network, a mesh network, a star-bus network, tree or hierarchical network, and the like. In some aspects, communication between systems in computing architecture 100 can occur via a virtual private network (VPN), Secure Shell (SSH) tunnel, or other secure network connection. In some aspects, the one or more networks may further include a corporate network (e.g., intranet) and one or more wireless access points.

Computing architecture 100 provides end users with the ability to participate in the tracking of budgets for matters. For example, a matter billing supervisor 118 can access user interface(s) provided by budget tracking system 102 to create and manage budgets for matters. In another example, a notification can be provided to a user recipient 120, who can correspond to the matter billing supervisor 118, a tracking delegate assigned by the matter billing supervisor, or a working timekeeper. In yet another example, clients can be provided with budget notifications from mail server 112, in conjunction with a firewall 116 and a client extranet system 114.

Each end user (e.g., any of end users 118, 120, 122, 128) can interface with computing architecture 100 via a computing device (not shown) which is in communication with one or more of the systems in computing architecture 100. The computing devices used for interfacing with the systems in computing architecture 100 can represent various forms of processing devices. Example processing devices can include a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices. In addition, the computing devices used for interfacing with the systems in computing architecture 100 may be provided access to or receive application software executed or stored on the systems in computing architecture 100.

Budget tracking system 102 (e.g., in conjunction with matter management system 110) executes computer instructions to track costs relative to an established budget. Budget tracking system 102 generates specialized alerts for sending to a billing supervisor or to other stakeholders (e.g., clients), with the alerts being based on actual costs relative to the budget. Budget tracking system 102 also sends alerts to individual timekeepers, to notify those timekeepers when their entered time has reached predefined thresholds relative to the budget. In addition, budget tracking system 102 provides a matter tracking interface which provides financial summary and a history of alerts.

In example aspects of tracking costs relative to a budget, budget tracking system 102 receives one or more cost values (e.g., timekeeper costs entered within time entry system 108, vendor costs, material costs or costs for other resources) for applying against a predefined budget, and compares the one or more cost values against preset threshold percentages (e.g., 65%, 80% or 100%) for the predefined budget, each preset threshold percentage indicating a percentage of costs applied against the predefined budget at which to notify users. Budget tracking system 102 determines, based on the comparison, whether the one or more cost values meet or exceed at least one of the preset threshold percentages. Budget tracking system 102 generates, in a case where the one or more cost values meet or exceed at least one of the preset threshold percentages, a notification for a first user who bills against the predefined budget and for a second user who supervises the predefined budget, the notification indicating which of the preset threshold percentages are met or exceeded by the one or more cost values. Budget tracking system 102 provides the generated notification (e.g., via mail server 112) to the first user and to the second user.

The creation of budget templates (e.g., heading II below), association of client matters with created budget templates (e.g., heading III below), and providing of alerts, reports and predictions (e.g., heading IV below) will now be described with reference to example user interfaces.

### II. Template For Creating A Budget

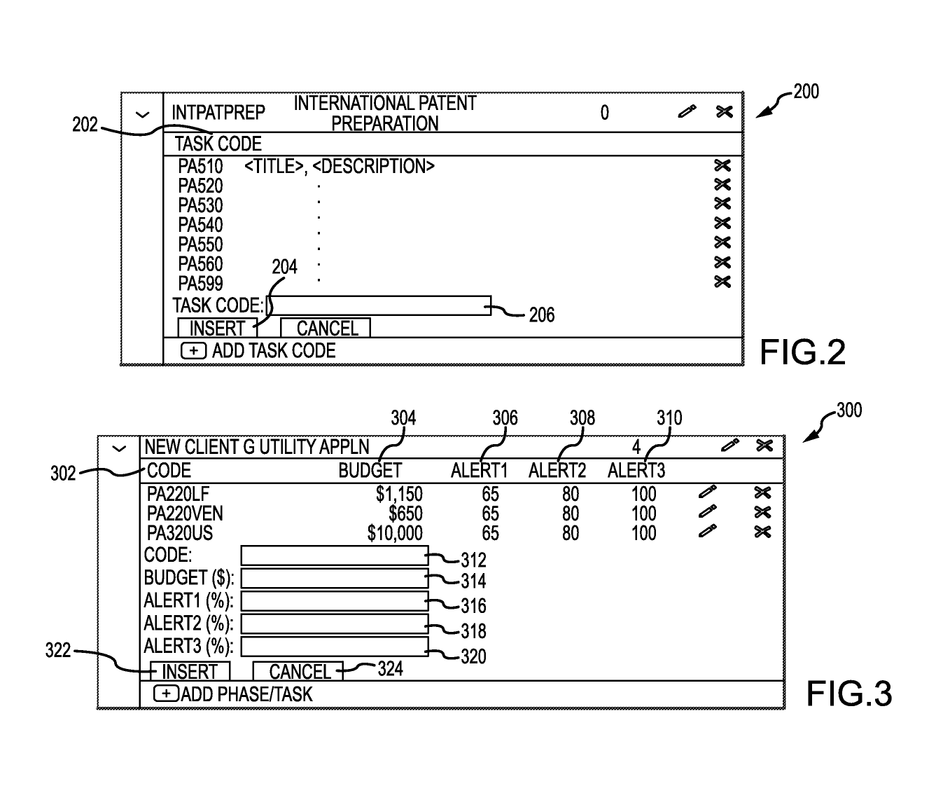

FIGS. 2-6 correspond to example interfaces for creating a budget template for a client matter (e.g., using budget tracking system 102). While FIGS. 2-6 may refer to client matters associated with patent law, budget tracking system 102 is not limited to such a service. Rather, budget tracking system can apply to a variety of service providers (e.g., legal, accounting, construction) that provide services for client matters associated with budgets.

In example aspects, budget tracking system 102 accesses data from one or more systems (e.g., within computing architecture 100) to provide for display the example user interfaces in FIGS. 2-6. The user interfaces may be displayed in a web browser as part of a website, or may be displayed within a native application (e.g., a mobile application or desktop application) of a user device.

As used herein, a ‘budget template’ refers to a template which defines the budget for a client matter. The budget template can refer to a generic client matter, and breaks that matter down into several tasks which are associated with completing the matter. The matter will typically have a total budget, which can be split among multiple tasks, each task having its own task code. Tasks can be logically grouped (e.g., by the billing supervisor) into one or more phases, each phase having its own phase code. Thus, a client matter can be comprised of one or more phases, each having its respective tasks, where the phases and tasks are designated by respective phase codes and task codes.

FIG. 2 illustrates an example user interface in which a task code is added to a phase code. Budget tracking system 102 provides for display of a user interface 200 (e.g., within a browser as part of a website or within a native application) to a computing device for a user. User interface 200 is part of the process of creating a new phase code, which as noted above, consists of multiple task codes. In the example of FIG. 2, user interface 200 displays different task codes within a task code column 202. The task codes represent different tasks that are associated with the phase of ‘international patent preparation.’ For example, each of task codes ‘PA510’ . . . ‘PA599’ can correspond to different tasks associated with the phase of ‘international patent preparation.’

The phase and respective tasks can be defined by a billing supervisor, or a delegate of the billing supervisor. Each of the task codes can include, among other information, a title and/or description corresponding to the task. A user such as the billing supervisor adds the appropriate tasks, using the insert button 204, by designating the task codes within the ‘task code’ input box 206.

FIG. 3 illustrates an example user interface in which an activity is added to a budget template. As noted above, a budget template corresponds to a generic client matter and can be divided into one or more phases, each with respective task(s), with each phase/task having a respective phase/task code. Budget tracking system 102 provides for display of user interface 300 (e.g., within a browser as part of a website or within a native application) to a computing device for a user. User interface 300 displays (e.g., in column format) the phase/task codes which make up the budget template, and the budget amount for each of the respective phases/tasks. In the example of FIG. 3, column 302 indicates task codes associated with a phase of a new utility application for client G.

Column 304 specifies a budget for each respective task, and columns 306, 308 and 310 specify different alert thresholds, which are named Alert1, Alert2 and Alert3 in this example. The alert thresholds can be preset by a user (e.g., billing supervisor) to indicate at which amount (e.g., percentage) of the budget a notification is to be provided to a recipient (e.g., the billing supervisor, timekeeper and/or client).

To add a new task with respective budgets and alerts, input box 312 provides for adding a new task code. In addition, input boxes 314, 316, 318 and 320 provide for a user to input a respective budget and alert thresholds for the new task code. This new task information can be committed within the system via insert button 322, or cancelled via cancel button 324.

When creating a budget template, billing supervisor 118 can define the various phases/tasks associated with the template using their respective codes, and can further specify the budgets for each phase/task. In this regard, user interface 300 includes graphical components for the removal or addition of new phases/tasks and their respective budget amounts. The various phases/tasks can represent the entire generic matter (e.g., budget template).

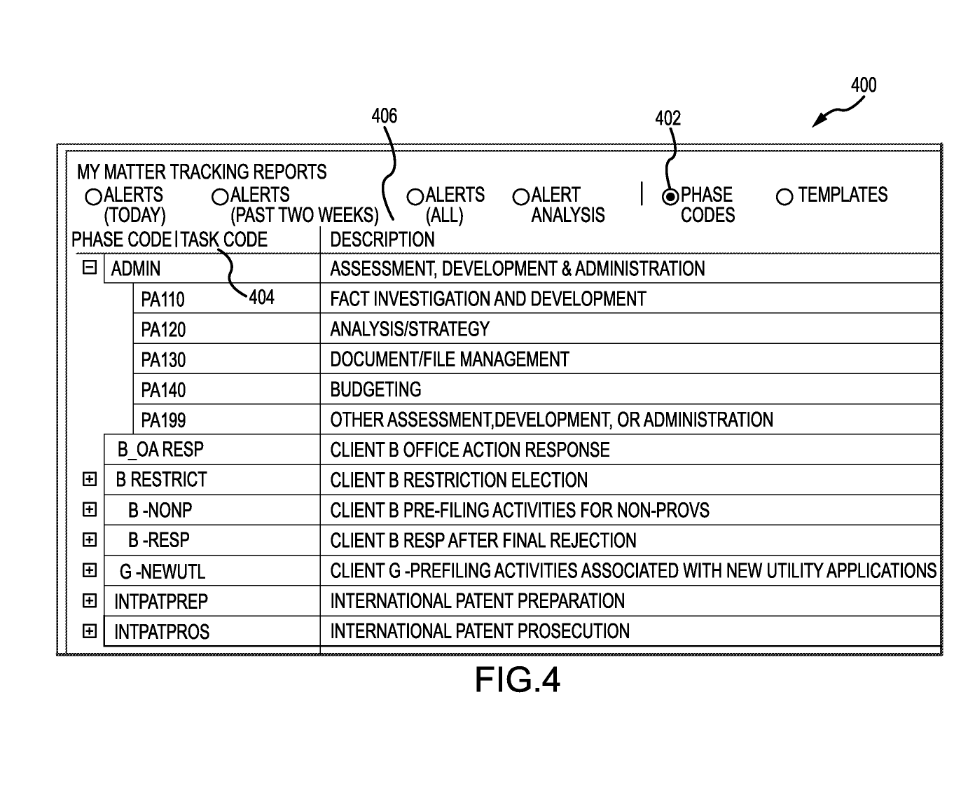

FIG. 4 illustrates an example user interface which displays a summary of defined phase codes. Budget tracking system 102 allows for the user (e.g., billing supervisor, delegate of billing supervisor) to see all of the phase codes defined for the billing supervisor, including the task codes included within each phase code. Budget tracking system 102 accesses data from one or more systems (e.g., within computing architecture 100) to provide for display of user interface 400 (e.g., within a browser as part of a website or within a native application) to a computing device for a user.

In the example of FIG. 4, the user selects radio button 402 to present all phases defined for the billing supervisor. The phase names are listed in column 404. In the example of FIG. 4, the phase names include an ‘Admin’ phase name for an administrative phase. The user can select ‘Admin’ (e.g., by selecting the ‘+’ button next to ‘Admin’) to present an expanded list of task codes, within column 404, which are included as part of the ‘Admin’ phase. In addition, column 406 provides a description associated with each phase name or task code.

FIG. 4 also illustrates other phase names (e.g., a restriction requirement for client B, non-provisional application for client B, response for client B, New utility application for client G, international patent preparation, international patent prosecution) within column 404, each of which can be expanded/collapsed to provide more/less detail about the particular phase (e.g., which task codes are associated with each phase). In addition, column 406 provides a description associated with each phase name or task code. Although phase names are illustrated in FIG. 4, it should be noted that phase codes (e.g., code identifiers) can be displayed as an alternative to or an addition to the phase name.

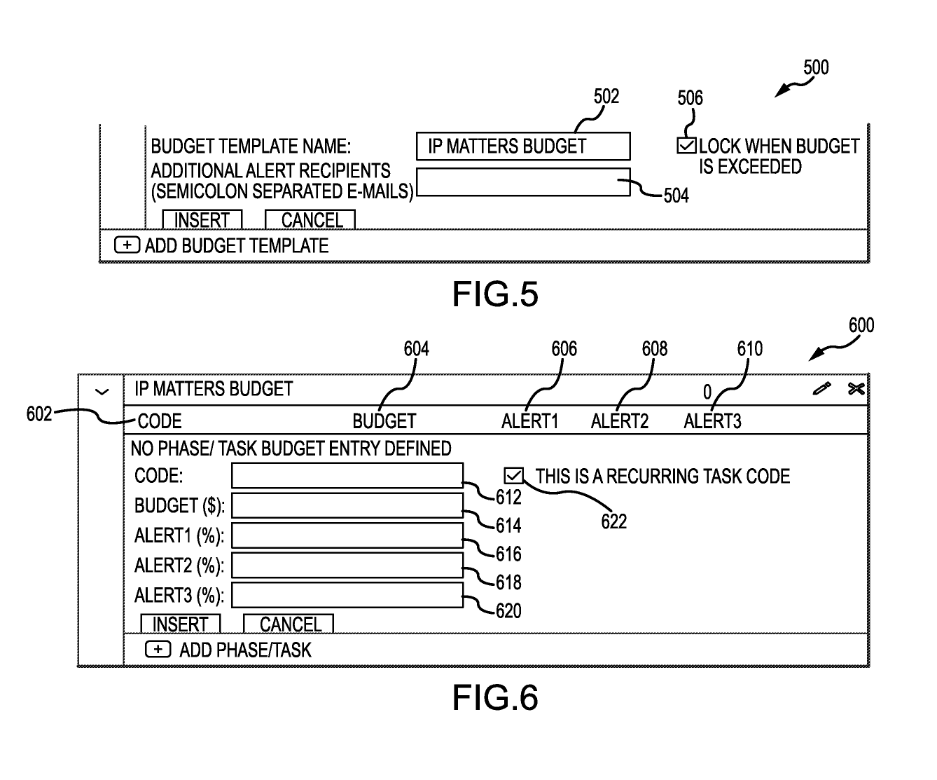

FIG. 5 illustrates an example user interface for creating a new a budget template. Budget tracking system 102 provides for display of user interface 500 (e.g., within a browser as part of a website or within a native application) to a computing device for a user. User interface 500 provides the ability for the user (e.g., billing supervisor, delegate of billing supervisor) to specify general parameters that will be applied to any matters that are tracked against the budget template. For example, the user can specify the name of the budget template within input box 502, and additional recipients, to receive email notifications when alert thresholds have been surpassed, within input box 204.

User interface further includes checkbox interface 506. Checkbox interface 506 provides the ability for a user to initiate a hold on a matter, for example, by locking out time entry in the time entry system for any tracked activities that have exceeded the defined budget. Initiating a hold on the budget can correspond to prohibiting subsequent costs from being applied to the budget, for example, prohibiting timekeeper costs from being entered within time entry system 108 until authorized by billing supervisor 118.

FIG. 6 illustrates an example user interface for entering task and phase codes for a budget template. Budget tracking system 102 provides for display of user interface 600 (e.g., within a browser as part of a website or within a native application) to a computing device for a user. User interface 600 provides the ability for the user to identify a particular task code as a ‘recurring’ task code via checkbox interface 622. In example aspects, recurring task codes allow a user to save budget amounts and alerts for re-use (e.g., in other matters, phases/tasks), without requiring the user to re-enter that data. Recurring task codes can be reset, where alerts are reset and actual billing amounts for a new budget are computed relative to current total values, and re-used within a tracked matter.

In user interface 600, column 602 indicates task code(s) associated with a phase. Column 604 specifies a budget for each respective task, and columns 606, 608 and 610 specify different alert thresholds. The alert thresholds indicate at which amount (e.g., preset percentage) of the budget a notification is to be provided to a user recipient (e.g., billing supervisor, timekeeper).

With reference to FIGS. 2-6, it should be noted that the hierarchy of a budget template is not necessarily limited to phases and tasks. Rather, budget tracking system 102 can be more generic, with matters simply including one or more tasks and no phases. Alternatively, budget tracking system can be more granular, where phases (or a like term) are divided into sub-phases, which can in turn be divided into smaller phases or tasks. In this regard, budget tracking system 102 can provide for task rollup, in which budgets are tracked at a greater level of granularity than allowed by predefined tasks (e.g., tasks defined by a client).

Thus, a hierarchy for a budget template can correspond to a tree structure, with the root node of the tree corresponding to a generic matter (e.g., a budget template), and with each of the edges from the root node including, as needed, additional nodes and edges (e.g., terminating in a leaf node corresponding to a task). Budgets can be established at any level within the tree. Budgets can be manually set (e.g., by a billing supervisor or delegate) at different nodes. Alternatively, the budgets for nodes which are not manually set can automatically calculated by adding the budgets of corresponding children nodes.

In addition, budget templates can vary for similar matters. Using the example of patent prosecution, in some instances, a generic budget template can be defined within budget tracking system 102 for the drafting of a patent application. However, as the technology for patent matters varies, it is possible for a user to define different budget templates (e.g., with matters broken down into phases/tasks) based on the technology. For example, the drafting of a patent application for semiconductor technology may be assigned a higher budget than that for mechanical technology. As such, the billing supervisor can designate phases/tasks, as well as budgets for the phases/tasks, appropriately.

Budget tracking system 102 can also maintain and adhere to funding arrangements specific to clients or client matters. For example, budget tracking system 102 maintains funding arrangements and automatically derives budget options based on specified arrangements with a client for a particular matter. One example is a ‘collar’ arrangement, in which billing rates for timekeepers can vary depending on the amount of budget remaining for a matter. For example, if all budget has been used for a particular matter, a collar arrangement can designate a reduced billing rate for any additional time entered by a timekeeper. Budget tracking system 102 can accommodate for ‘collar’ or other arrangements (e.g., via user interface fields for the billing supervisor), and adjust budget tracking for that matter accordingly.

It should be noted that budget tracking system 102 is not limited to task-based budgeting, in which budgets are assigned to tasks. In example aspects, budgets can alternatively or additionally be based on time periods. As such, budget tracking system 102 can establish and track budgets against a time period (e.g., monthly, weekly, etc.) for activities. Notifications and alerts (described in greater detail below) can be tracked based on how much the budget is used within the time period, rather than based on how much budget has been used for individual phases/tasks.

Furthermore, budget tracking system 102 is not limited to costs associated with timekeepers, where timekeeper budgets are calculated based on time entered by a timekeeper multiplied by respective billing rates for the timekeeper. Rather, budget tracking system 102 can budget and track all costs related to a matter, including hard and soft costs. These costs can include, but are not limited to, timekeeper costs, vendor costs and costs for materials or other resources.

By way of non-limiting example, a construction project for a matter can include costs for labor and materials, each of which can partially be subcontracted out to third-party vendors. Budget tracking system 102 can budget and track all costs associated with such labor and materials, for example, by receiving information provided by systems associated with the third-party vendors. Budget tracking system can generate appropriate alerts and notifications based on the tracked budget for these costs.

### III. Template For Associating A Matter With A Budget

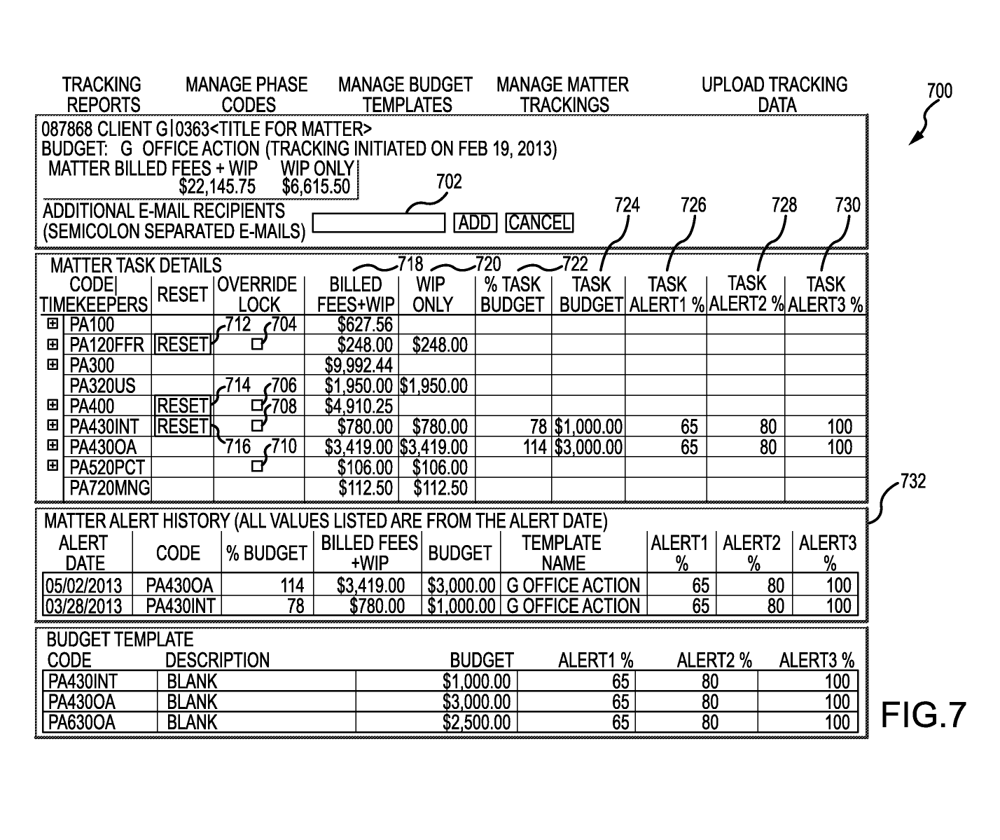

As noted above, a budget template can refer to a generic client matter, and can break that matter down into several tasks which are associated with completing the matter. With reference to FIGS. 7-11, once a budget template has been created by a user (e.g., a billing supervisor or delegate thereof), the user can associate the budget template with a specific client matter. Using patent prosecution as an example service, the user can associate a new matter of drafting a patent application for a client with a previously-defined budget template for patent application drafting.

In assigning a new matter to a predefined budget template, the new matter may be subject to the budget requirements defined by the budget template. However, budget tracking system 102 can permit the user to override parameters of the budget template for a particular client matter. Thus, budget tracking system 102 provides for inheritance and override of budget tracking features. This allows for common attributes for a budget (e.g., value, alerts, email recipients, time hold, etc.) to be established on a template which can be applied to multiple matters, and the ability to allow for those values to be over-ridden at the individual matter level.

Budget tracking system 102 provides for automatically populating a budget template for multiple matters. For example, automatic population with a budget template can be used for a client with tens, hundreds or thousands of matters for a similar job.

FIG. 7 illustrates an example user interface for adjusting parameters within a budget template for a particular client matter. Budget tracking system 102 accesses data from one or more systems (e.g., within computing architecture 100) to provide for display of user interface 700 (e.g., within a browser as part of a website or within a native application) to a computing device for a user. User interface 700 provides for overriding or extending certain configuration options for tracking a matter which have been set at the budget template level.

Using input box 702, the user can specify extra email recipients to receive alerts for thresholds surpassed for a matter (e.g., as opposed to all matters tracked under the same budget template). The user can also override the template-level setting for locking out time entries when the budget has been surpassed, for example, using checkbox interfaces 704, 706, 708 or 710.

In addition, using buttons 712, 714 and 716, the user can perform a manual ‘reset’ for a recurring task code. When the task code is reset, the tracking parameters for the task code will be re-valued relative to current actual amounts. For example, computing actual amounts against the budget for an item will start with current actual values being effectively $0.00, and all alerts can be reset and can be re-triggered for actual values to accumulate.

In example aspects, the reset can be automated based on predefined criteria specified by the user. The predefined criteria includes, but is not limited to, completion of a task, an increase in budget, and the addition of tasks or subtasks to a matter. Thus, an activity being tracked within a budget can be repeated, by effectively resetting the alerts and baseline for the activity based on the specified criteria. Budget tracking system 102 therefore provides the ability to reset alerts which have already been triggered for a tracked item, based on changes to the budget data (e.g., increased budget, added tasks) being used for tracking of the matter.

As noted above, computing architecture 100 can provide for communication between docketing system 104 and budget tracking system 102, for integration of docketing data with budget tracking In other words, budget tracking system 102 can receive docketing information from docketing system 104, to create and update tasks and budgets. Thus, instead of manual input from a user, the creation and updating of budgets (e.g., to trigger a reset) can be based on real-time (or substantially real-time) information of matters obtained from docketing system 104.

In example aspects, column 718 displays the billed fees and WIP costs for each task. Column 720 displays the WIP only for each task. Column 722 displays the percentage of task budget used based on costs, and column 724 displays the defined task budget. In addition, columns 726, 728 and 730 display alert thresholds set for each task. User interface 700 further includes a matter alert history interface 732 for displaying a history of alerts, including when an alert was sent for a particular task (or phase), including the alert date and respective alert threshold.

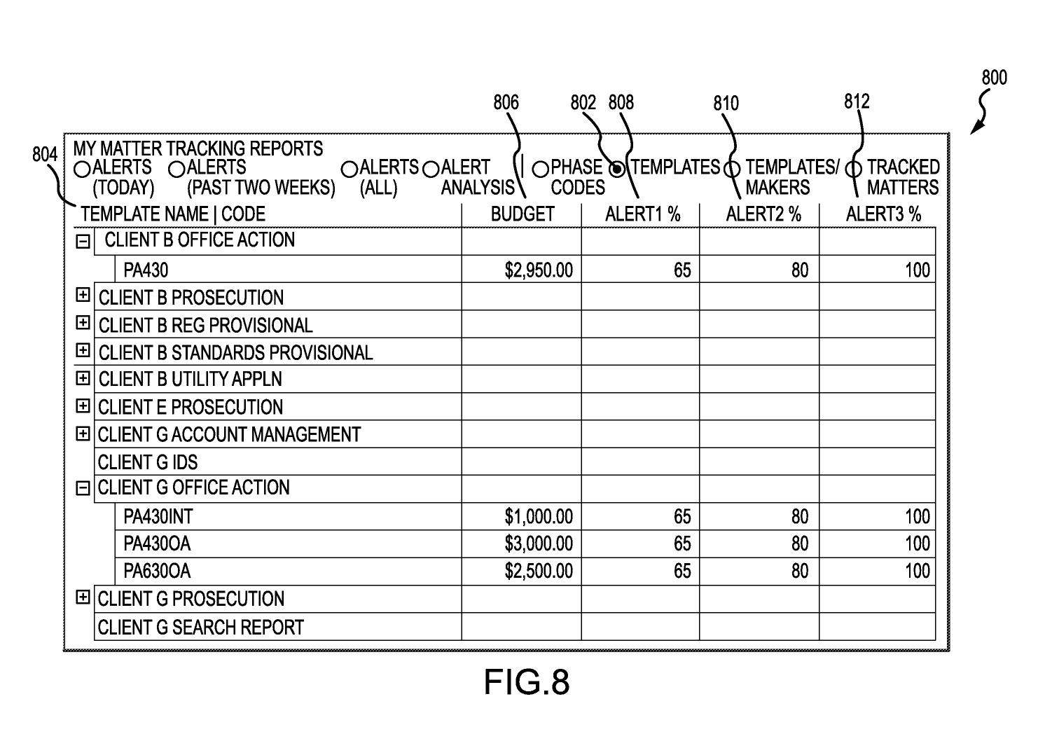

FIG. 8 illustrates an example user interface for displaying a summary of budget templates. Budget tracking system 102 accesses data from one or more systems (e.g., within computing architecture 100) to provide for display of user interface 800 (e.g., within a browser as part of a website or within a native application) to a computing device for a user. By selecting radio button 802 within user interface 800, the user can view a listing of all defined budget templates, including the detail for each template. The details can include, but are not limited to, budget, alert and thresholds information.

The template names are listed in column 804. The user can select a particular template (e.g., via the ‘+’ button corresponding to ‘Client B Office Action’) to present an expanded list of task codes (and/or phase codes), within column 804, which are included as part of the ‘Client B Office Action’ template. In addition, column 806 provides for a corresponding budget associated with the expanded tasks, and columns 808, 810 and 812 provide for respective alert thresholds associated with the tasks.

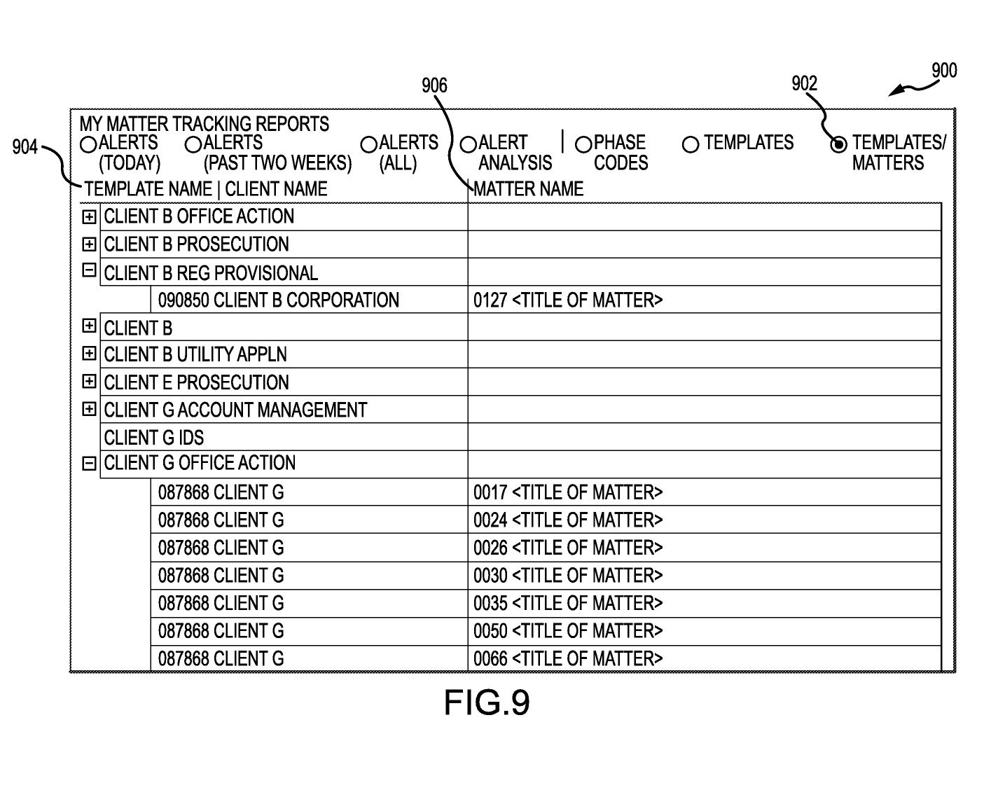

FIG. 9 illustrates an example user interface for displaying all matters being tracked by a budget template. Budget tracking system 102 accesses data from one or more systems (e.g., within computing architecture 100) to provide for display of user interface 900 (e.g., within a browser as part of a website or within a native application) to a computing device for a user. By selecting radio button 902 within user interface 900, the user can view which matters are currently being tracked, as grouped by the budget template to which the matters are associated.

The template names are listed in column 904. The user can select a particular template (e.g., via the ‘+’ button corresponding to ‘Client G Office Action’) to present an expanded list of client and matter numbers which are being tracked and correspond to the ‘Client G Office Action’ template. In example aspects, the matter numbers and description information (e.g., title) are presented in a separate column 906.

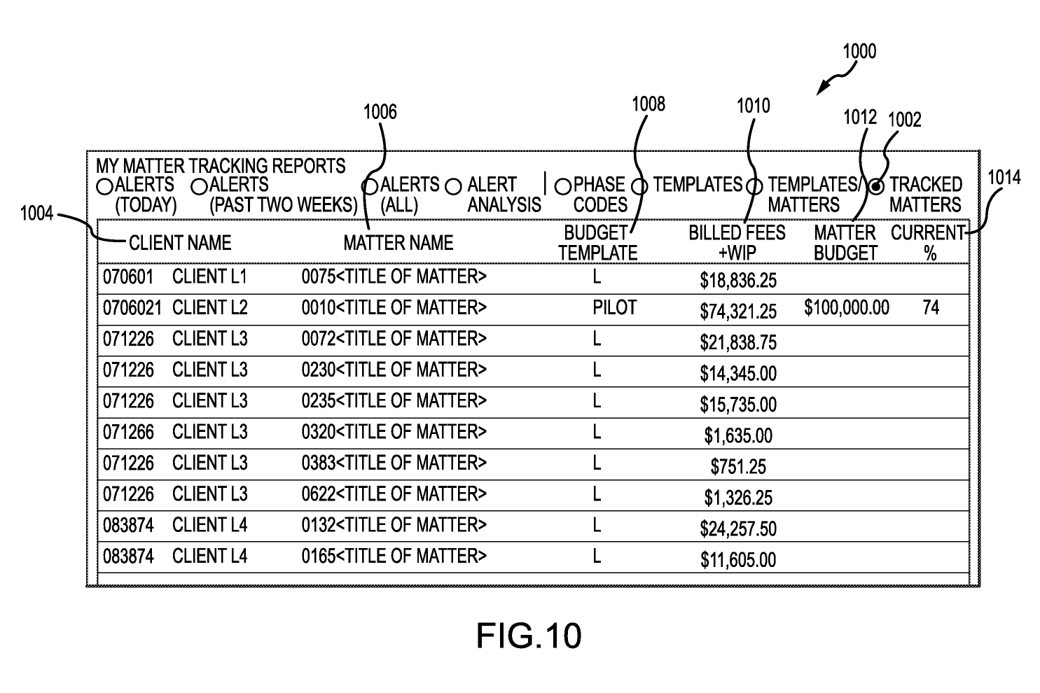

FIG. 10 illustrates an example user interface for displaying all matters being tracked by a budget. Budget tracking system 102 accesses data from one or more systems (e.g., within computing architecture 100) to provide for display of user interface 1000 (e.g., within a browser as part of a website or within a native application) to a computing device for a user. By selecting radio button 1002 within user interface 1000, the user can view all matters currently being tracked at a summary level. In addition, user interface 1000 provides the user with the ability to obtain details for each matter, by drilling down to the respective matter detail page, in response to user selection of a particular matter (e.g., mouseclick or touch input for the matter number).

The client numbers and/or client names are listed in column 1004, and the matter numbers are listed in column 1006. The corresponding budget template description (e.g., title) is provided in column 1008. In addition, costs such as billed fees and WIP are provided in column 1010 and defined budgets in column 1012. A current percentage of costs (e.g., billed fees and WIP) relative to the budget are provided in column 1014.

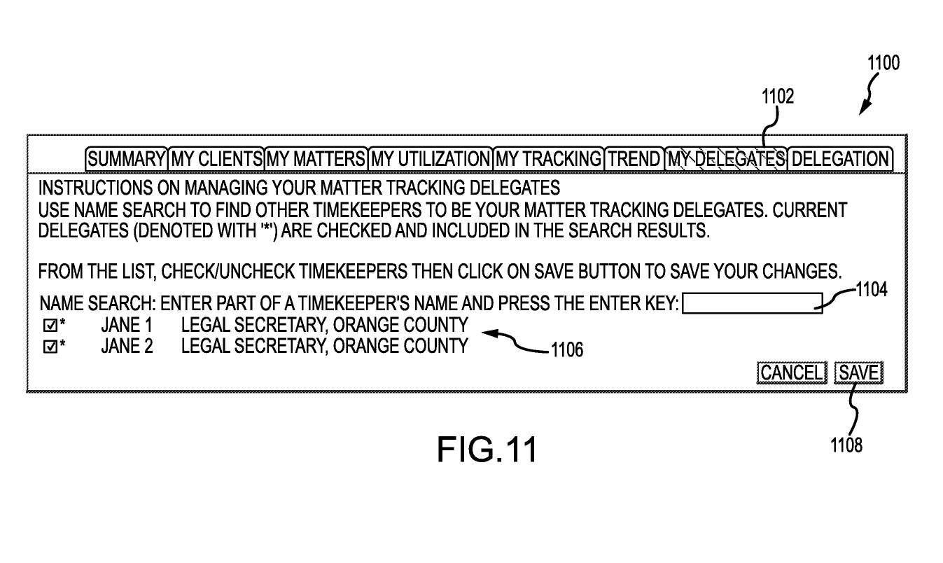

FIG. 11 illustrates an example user interface for a billing supervisor to delegate responsibility to others for managing and viewing budget information on behalf of the billing supervisor. As noted above, a billing supervisor can delegate responsibility for budget management (e.g., to an administrative assistant of the billing supervisor). By selecting tab 1102 within a tabbed interface, the billing supervisor can delegate responsibility to others to both manage the budget information on their behalf, and to view the matter tracking reports and information.

In example aspects, the billing supervisor or delegate can input a name in input box 1104, to search for the names of individuals to be selected as delegates. The search results can be provided in list 1106. The billing supervisor can select the delegates via checkboxes within list 1106, and commit the individuals as delegates via save button 1108.

### IV. Providing Alerts, Reports And Predictions

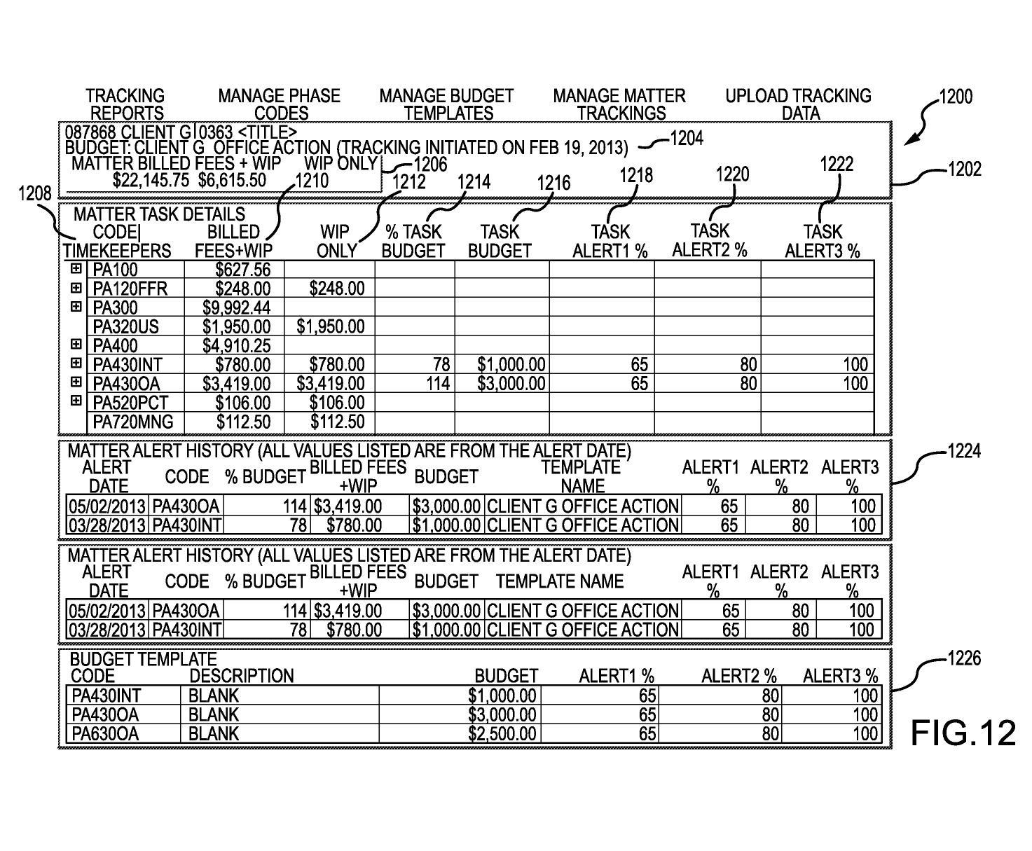

With reference to FIGS. 12-19, based on the budgets templates assigned to a matter, budget tracking system 102 can provide notifications to end users (e.g., billing supervisors or delegates thereof, timekeepers, clients), based on the rules (e.g., budgets, alerts) defined for the particular matter. As noted above with reference to FIG. 3, user interface 300 allows the user to define alerts (e.g., alerts 306-310 corresponding to Alert1-Alert3), each of which correspond to a percentage of the budget for a task/phase/matter. In addition to sending alerts, budget tracking system 102 can provide for summaries and analysis of alerts, and can further provide for initiating a hold (e.g., locking time) within time entry system 108 in a case where the actual cost for a matter surpasses the budget.

FIG. 12 illustrates an example user interface of a matter detail screen with consolidated information pertaining to a client matter being tracked. Budget tracking system 102 accesses data from one or more systems (e.g., within computing architecture 100) to provide for display of user interface 1200 (e.g., within a browser as part of a website or within a native application) to a computing device for a user. User interface 1200 provides a consolidated summary of the information pertaining to a matter being tracked.

For example, user interface 1200 provides an overview interface 1202 of the billed actual values for the matter (billed+WIP). For example, interface section 1204 indicates a particular client and matter number (with title), and interface section 1206 indicates the actual billed fees and WIP for that client and matter number.

User interface 1200 further provides for a decomposition of the billings per phase code and task code, with the ability to drill into each to see individual timekeepers who have billed to the activity down to the detailed time entries for each. Column 1208 displays multiple phase/task codes, each which can be expanded (e.g., via ‘+’ buttons) to display the individual timekeepers who have billed to that code. In addition, the individual timekeeper information may display the amount of time and cost billed to that code.

In this regard, budget tracking system 102 can further provide for displaying the associated timekeeper for each task/phase code in which budget has been surpassed, together with an interface to generate an email for sending to that timekeeper. In this manner, the billing supervisor can simply click on a timekeeper associated with a task over budget and email that timekeeper for the status of that matter. In example aspects, the subject line for the generated email can be automatically populated with the appropriate client matter and task information.

User interface 1200 further includes column 1210 for displaying billed fees+WIP for each phase/task code, column 1212 for displaying WIP only, column 1214 for displaying the percentage of task budget used, and column 1216 for displaying the defined task budget. In addition, columns 1218, 1220 and 1222 display separate task alert thresholds for the phase/task.

User interface 1200 further includes a history interface 1224, which displays a history of all threshold alerts exceeded by the matter activities being tracked, and identifies the budget template to which the matter is being tracked. In addition, user interface 1200 includes a budget template interface 1226 for displaying the code, description, budget and alert thresholds of defined budget templates.

As noted above, notifications can be generated and sent to user recipients in a case where the amount of costs (e.g., billed fees and/or WIP) meet or exceed predefined alert thresholds. The user recipients can include billing supervisors, delegates of the billing supervisors, timekeepers and/or clients.

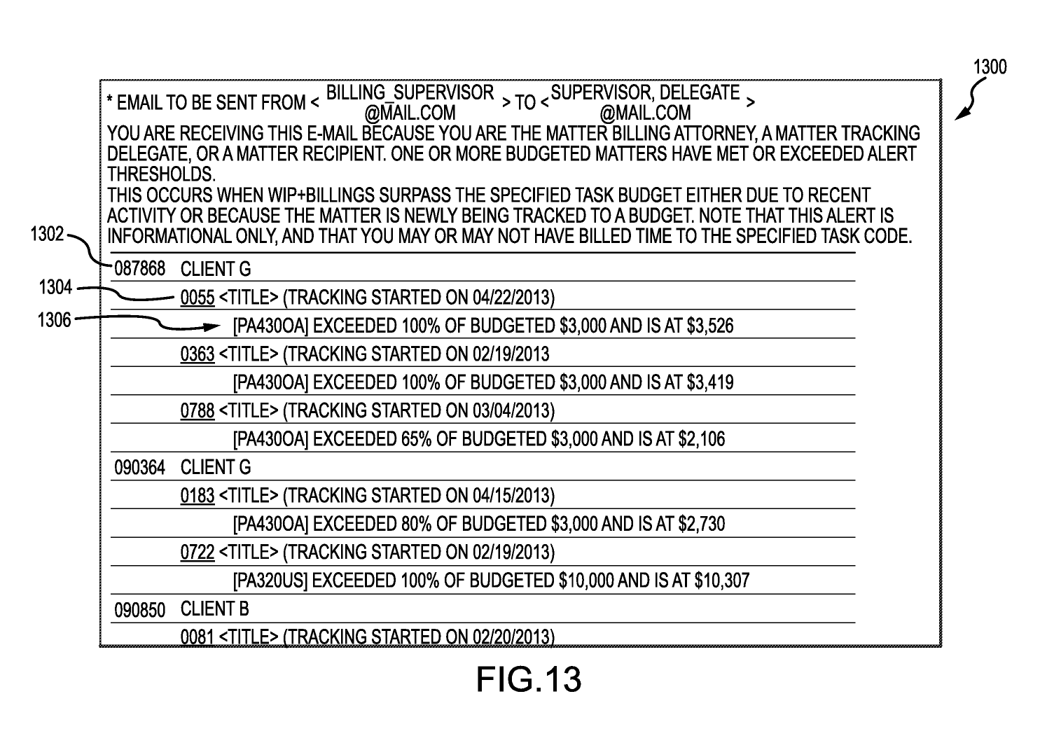

FIG. 13 illustrates an example of an email notification including alert thresholds surpassed for client matters (e.g., phases and/or tasks) for a billing supervisor or delegate thereof. Budget tracking system 102 accesses data from one or more systems (e.g., within computing architecture 100) to provide for the generation and sending of email message 1300 (e.g., via mail server 112). Email message 1300 represents the email sent out (e.g., on a periodic basis such as daily or upon an alert threshold being exceeded) summarizing all surpassed threshold alerts for all tracked matters for a particular billing supervisor. In example aspects, all alerts are combined into a single email for the user. The alerts for an individual matter can be hyperlinked, such that one of the hyperlinked matters navigates the user to a matter detail online screen (e.g., user interface 1200).

In the example of FIG. 13, alerts are grouped by client (e.g., client identifier 1302), where each client has one or more matter numbers (e.g., matter identifier 1304) for which an alert has been generated. In addition, a description 1306 can indicate the title for the matter, phase/task code, the percentage of budget that has been met or exceeded, the defined budget, and the actual costs (e.g., billed time and/or WIP).

It should be noted that different emails can be generated for different end users. For example, email message 1300 can be sent to the billing supervisor and/or any designated delegates thereof. In other examples, push notifications (e.g., in the form of email, text messages, etc.) for budget alerts are provided, allowing for multi-form notifications to a variety of recipients based on actual billings meeting/exceeding specified budget thresholds. For example, while the billing supervisor may receive email message 1300 indicating all threshold alerts for all matters associated with the billing supervisor, separate emails can be sent to individual timekeepers who entered time for a particular matter.

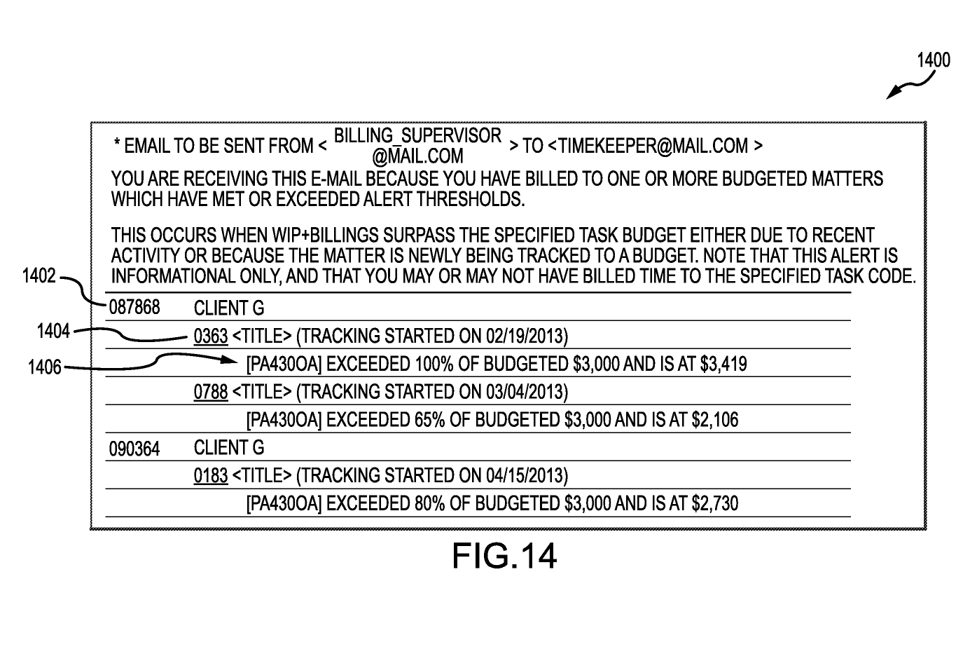

FIG. 14 illustrates an example of an email notification including alert thresholds surpassed for client matters for a timekeeper. Email message 1400 can be sent on a periodic basis (e.g., daily) or upon an alert threshold being triggered, to working timekeepers. Email message 1400 shows alerts relevant to matters they have worked on. Alerts for a working timekeeper can optionally be set up so that they receive an alert if they have billed any time to the matter (whether or not their time was entered against a tracked activity). Alternatively, the timekeepers can receive alerts for only activities they have billed to which have exceeded an alert threshold. In example aspects, email 1400 does not include hyperlinks to the matter detail online screen, since the individual timekeepers may not have the proper authority to view such information.

In the case where multiple timekeepers are assigned to a shared client matter, an individualized email message 1400 can be sent to all timekeepers who have ever entered time for that matter. Alternatively, such email messages can be filtered at the task/phase level for timekeepers assigned to respective tasks/phases, or can be filtered based on whether individual timekeepers are still assigned to the matter. In this regard, budget tracking system 102 can access information (e.g., from docketing system 104 or matter management system 110), to determine which timekeepers are assigned to tasks/phases, and which timekeepers are still assigned to the matter.

In the example of FIG. 14, alerts are grouped by client (e.g., client identifier 1402), where each client has one or more matter numbers (e.g., matter identifier 1404) for which an alert has been generated. In addition, a description 1406 can indicate the title for the matter, phase/task code, the percentage of budget that has been met or exceeded, the defined budget, and the actual costs (e.g., billed time and/or WIP).

It should be noted that the alerts can be generated in association with an automatic process/job run at periodic intervals (e.g., daily) for budget tracking system 102. For example, budget tracking system 102 can run the periodic job for all matters once a day, to determine which tasks/phases/matters surpassed budget and to notify the appropriate parties that budget has been surpassed.

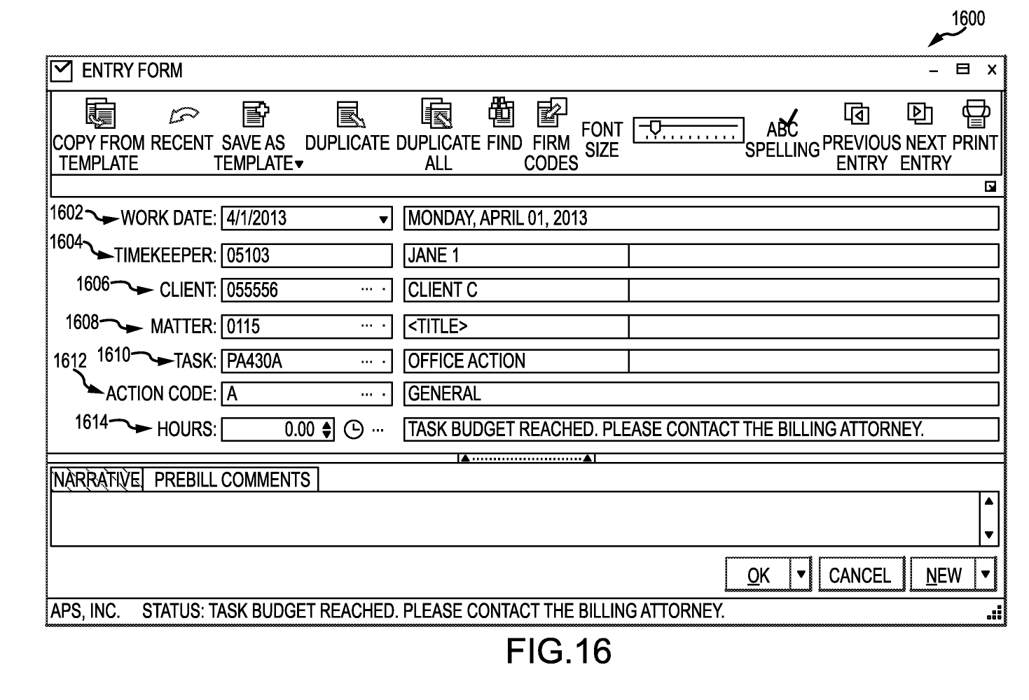

Alternatively, or in addition, budget tracking system 102 can check for the surpassing of budgets in real-time (or substantially real-time), at every instance time entered via time entry system 108 (e.g., and accessible via matter management system 110) is received by budget tracking system 102. Budget tracking system 102 can log these alerts as they occur, and wait to send the alert notifications on a periodic basis (e.g., every day) or send the alerts in real-time (or substantially real-time). In this manner, it is possible for budget tracking system 102 to alert time entry system 108 that a current time entry exceeds budget, thereby triggering time entry system 108 to prevent that current time entry from being entered. Such prevention of entering time will be described in greater detail below with reference to FIG. 16.

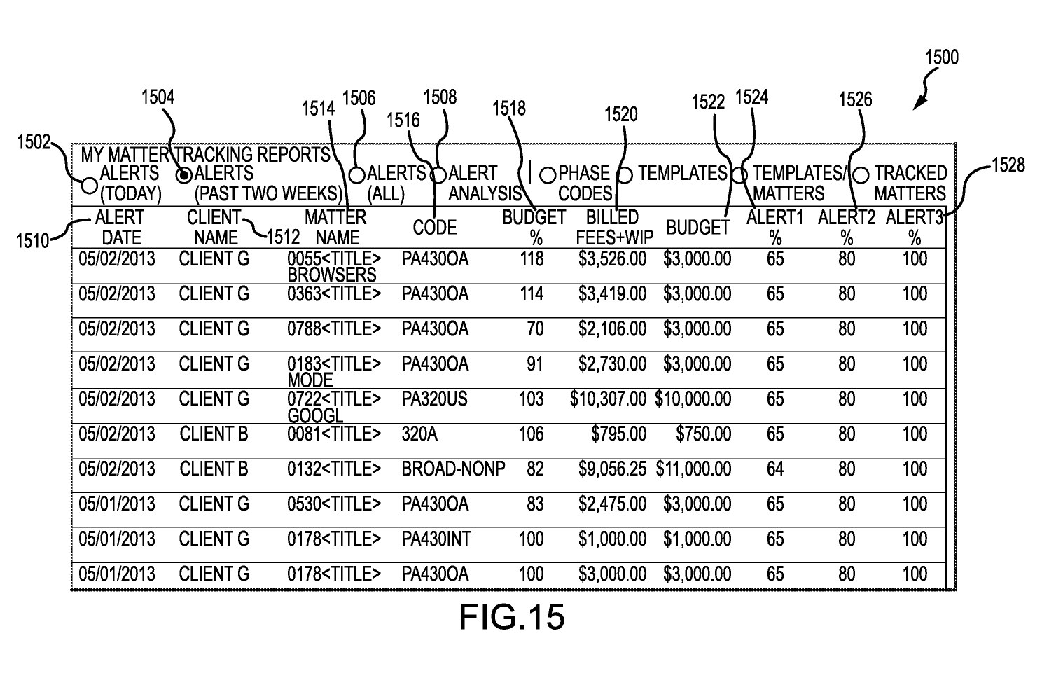

FIG. 15 illustrates an example user interface displaying a historical summary of generated alerts. Budget tracking system 102 accesses data from one or more systems (e.g., within computing architecture 100) to provide for display of user interface 1500 (e.g., within a browser as part of a website or within a native application) to a computing device for a user. By selecting radio button 1502, 1504, 1506 or 1508 within user interface 1500, the user can view a listing of all alerts generated over different periods of time. For example, the user may review alerts for the current day via radio button 1502, alerts for a time period (e.g., two weeks) via radio button 1504, or all alerts via radio button 1506. Further, the user can select to view alert analysis (e.g., metrics related to generated alerts) by selecting radio button 1508.

Column 1510 displays the date alerts were generated (and/or sent), column 1512 and 1514 display the client and matter numbers (e.g., with descriptions, such as title). Column 1516 displays the associated phase/task code. Column 1518 displays the percentage of budget used based on costs, and column 1520 displays the billed fees and WIP for the phase/task. Column 1522 displays the defined budget, and columns 1524, 1526 and 1528 display different alert thresholds associated with the phase/task.

FIG. 16 illustrates an example user interface of an error message, within a time entry system, indicating that budget has been exceeded. Budget tracking system 102 accesses data from one or more systems (e.g., within computing architecture 100) to provide for display of user interface 1600 to a computing device for a user. For example, the alert can appear within user interface 1600 while the user is attempting to enter time within time entry system 108.

User interface 1600 includes a work date row 1602 including an input box for inputting a work date, together with a description field (e.g., day of week, and spelled-out date). Timekeeper row 1604 includes an input box for inputting a timekeeper code (e.g., which uniquely identifies a timekeeper), together with a description field (e.g., full name of timekeeper).

Client row 1606 includes an input box for inputting a client number (e.g., which uniquely identifies a client), together with a description field (e.g., full name of the client). Client row 1608 includes an input box for inputting a matter number (e.g., which uniquely identifies a matter associated with a client), together with a description field (e.g., title of the matter). Client row 1610 includes an input box for inputting a phase and/or task code, together with a description field (e.g., description of the phase/task). Client row 1612 includes an input box for inputting an action code, together with a description field for that action. In example aspects, an “action” can correspond to a subset of a phase/task, as part of completing the phase/task.

User interface 1600 further includes row 1614 for user entry of time. A message can be presented within display box 1616, indicating that a phase/task budget has been reached, and that the entered time cannot be submitted until approved by a billing supervisor. Such message corresponds to a hold which was initiated for the particular phase/task. The billing supervisor, through a separate interface, may be required to release the hold in order for the time to be accepted in a subsequent time entry attempt by the timekeeper.

Thus, the systems described herein (e.g., within computing architecture 100, for example, matter management system 110 and budget tracking system 102) can prevent the release of timekeeper time entries based on the budgetary status of the matter. In addition, the message can be presented to the end user (e.g., timekeeper) who has entered time within time entry system 108, where the time has been rejected as the task code charged is over budget.

As noted above, timekeepers typically enter time for tasks/phase related to a client matter. Matter management system 110 can update the client matter in real-time (or substantially real-time), so that the actual billing values stored by matter management system 110 are continuously updated as time is entered.

In the event where a timekeeper enters time, the systems (e.g., matter management system 110 and budget tracking system 102) can determine if that entered time will exceed the budget. In doing so, the systems can compare [the amount of time entered]×[the billing rate of the timekeeper]+[the current actual billing value] with the budget for the particular task (or phase or matter), to determine if budget has been exceeded. If the budget is surpassed, the systems can send indication of the exceeded budget to time entry system 108, which in turn can flag that time entry as in excess of budget. User interface 1600 can display the message alert (e.g., within display box 1616), indicating that the entered amount of time exceeds the budget, and prevent the time entry from being entered and stored within matter management system 110.

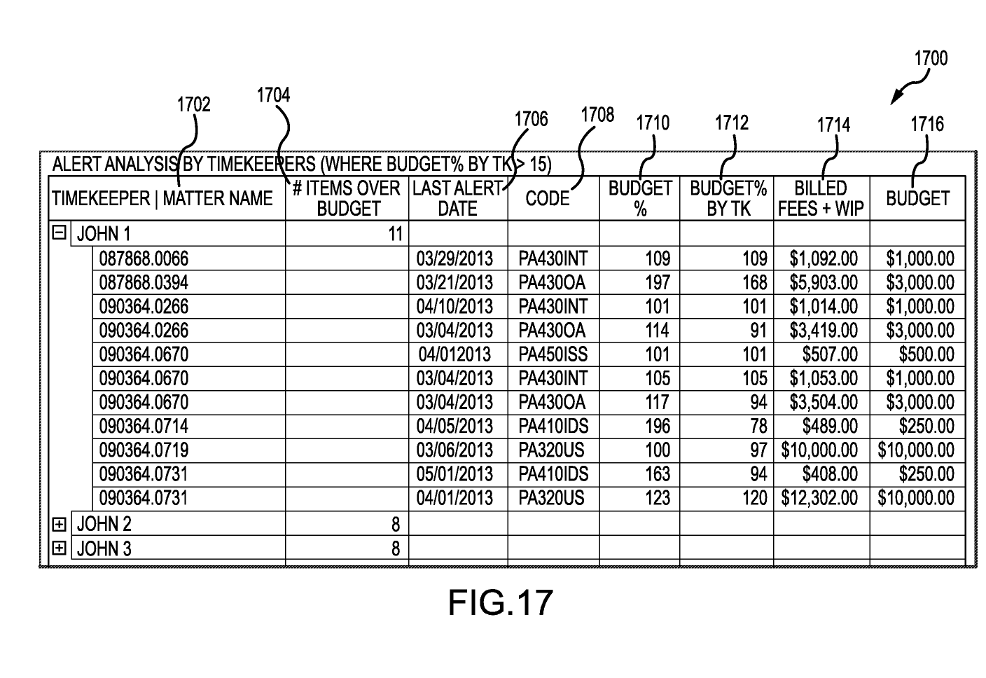

FIG. 17 illustrates an example user interface displaying an alert analysis for timekeepers. User interface 1700 provides the user with the ability to view the historical performance of timekeepers relative to exceeding budget thresholds for tracked activities. More particularly, user interface 1700 displays the number of times the timekeeper has billed to an over-budget activity, and provides details regarding each over-budget situation. Such details include, but are not limited to, percentage over budget, actual fees+WIP, and the budget amount.

Column 1702 provides for display of different timekeepers. To expand alert analysis for a particular timekeeper, a billing supervisor can select the “+” button associated with that timekeeper. For each timekeeper, column 1704 indicates the number of items (e.g., matters, phases/tasks) over budget. In the expanded mode, column 1706 displays the last alert date, column 1708 displays the phase/task code(s), and column 1710 displays the percentage over budget.

Column 1712 displays the percentage of budget attributed to that timekeeper. For example, if multiple timekeepers are associated with a matter, each timekeeper may have a different percentage of the attributed budget, but may all share the same percentage over budget. Column 1714 displays the amount of billed fees and WIP for the matter, and column 1716 displays the defined budget.

Thus, budget tracking system 102 can provide for timekeeper trend analysis based on historical performance to budget. The user can view historical trends with regard to timekeeper's conformance to meeting budgetary constraints.

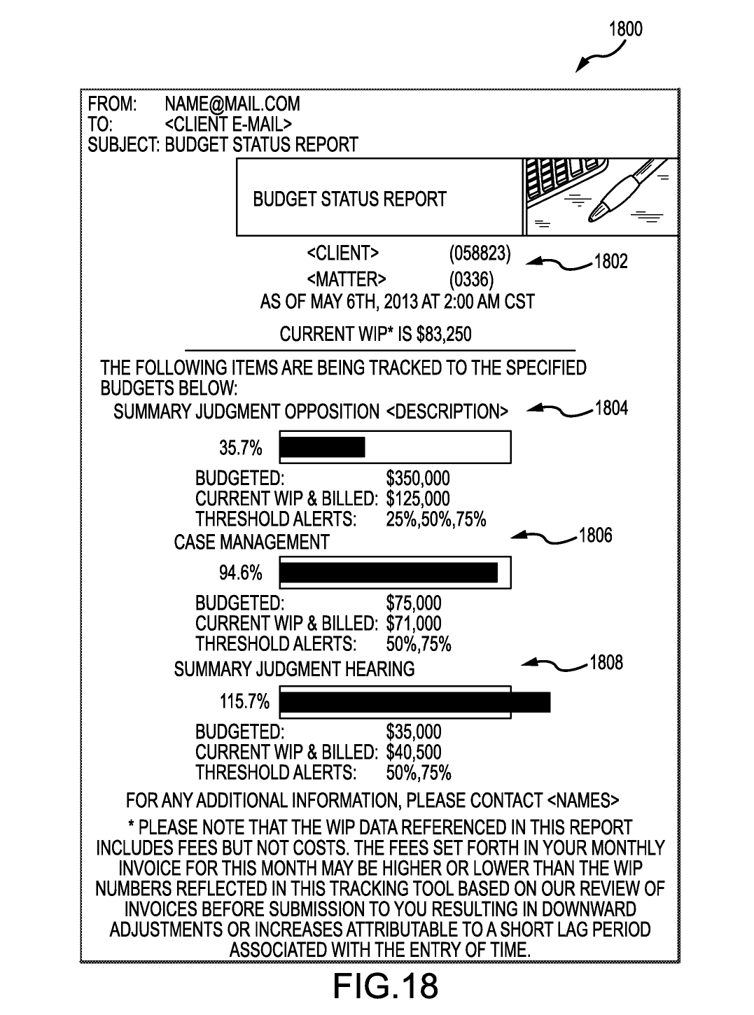

FIG. 18 illustrates an example email message providing an update of budget tracking status to a client. Budget tracking system 102 accesses data from one or more systems (e.g., within computing architecture 100) to provide the generation and sending of email message 1800 (e.g., via mail server 112). Budget tracking system 102 can send the email using one or more of mail server 112, firewall 116 or client extranet 114.

Email message 1800 provides a notification or update to external recipients (e.g., clients) based on budgetary matter tracking Thus, budget tracking system 102 provides the ability to automatically generate client budgetary status reports and notices to budget thresholds being exceeded. Email message 1800 can be sent to clients on a periodic basis, where the period is configurable and can be established uniquely for each client (daily, weekly, etc.).

In the example of FIG. 18, a client matter 1802 is divided into different phases/tasks 1804, 1806 and 1808, with a summary provided for each. For example, each of phases/tasks 1804, 1806 and 1808 includes a text description and graph indicating the budgeted amount for that phase/task, the current WIP and billed time for that phase/task, and the threshold alerts that have been met or exceeded for that phase/task.

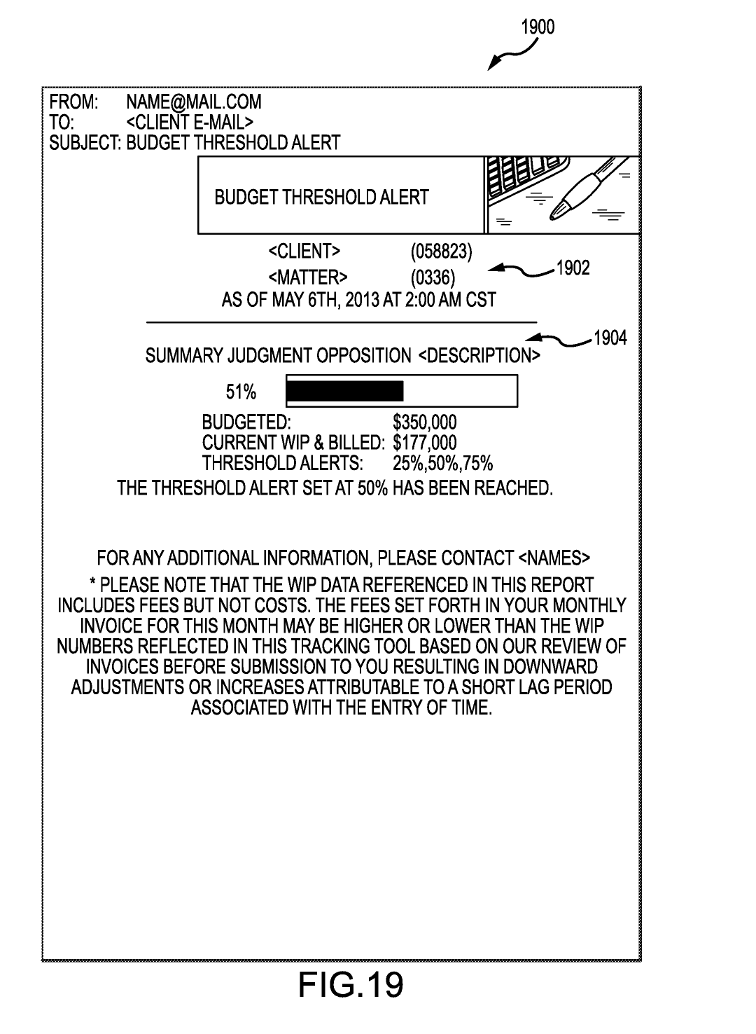

Furthermore, FIG. 19 illustrates an example email notification providing an alert to a client that budget has been exceeded. Email message 1900 is sent by budget tracking system (e.g., using one or more of mail server 112, firewall 116 and client extranet 114), to notify the client when a specific alert threshold for an activity being tracked has been surpassed.

In the example of FIG. 19, a client matter 1902 can be divided into different phases/tasks, including phase/task 1904. Phase/task 1904 includes a text description and graph indicating the budgeted amount for that phase/task, the current WIP and billed time for that phase/task, and the threshold alerts that have been met or exceeded for that phase/task. In addition, phase/task 1904 includes an alert a threshold has been reached. For example, alerts can be provided to the client on a periodic basis (e.g., daily) or in real-time (or substantially in real-time), when the alert threshold has actually been met or exceeded.

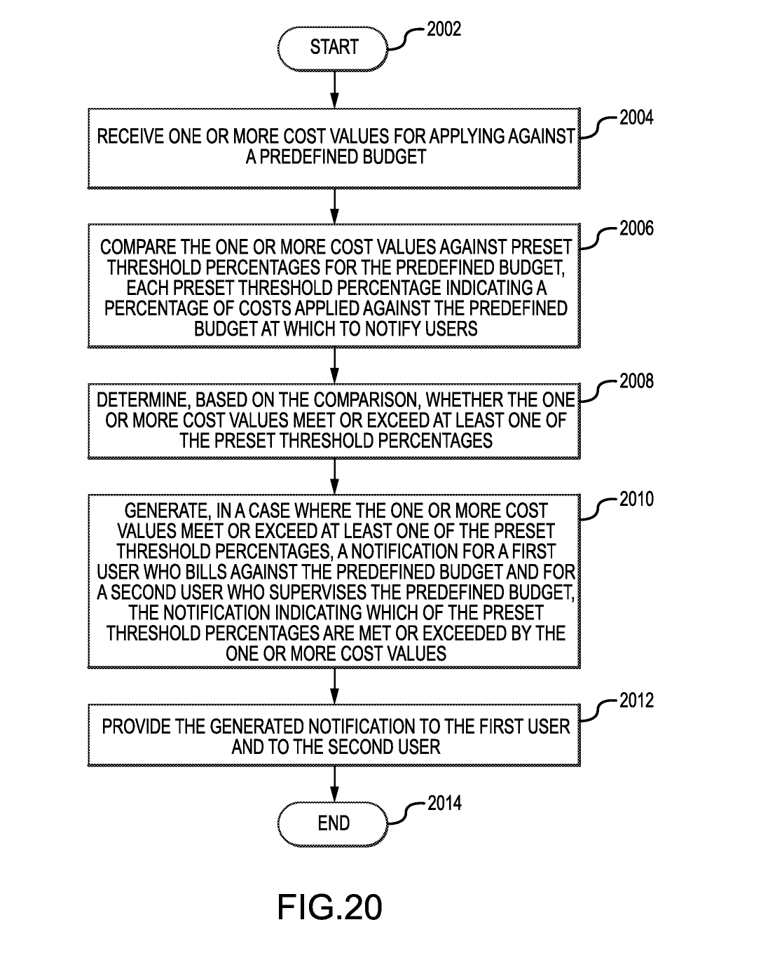

FIG. 20 illustrates an example process by which costs are tracked relative to a budget. Following start block 2002, one or more cost values for applying against a predefined budget are received at block 2004.

The one or more cost values can include at least one of timekeeper costs, vendor costs, material costs or costs for other resources. Receiving the cost values for the timekeeper costs can include tracking the timekeeper costs as they are entered within a time entry system. The timekeeper costs can be entered within the time entry system using time entry codes associated with the predefined budget.

At block 2006, the one or more cost values are compared against preset threshold percentages for the predefined budget. Each preset threshold percentage indicates a percentage of costs applied against the predefined budget at which to notify users. One of the preset threshold percentages can correspond to the entirety of the predefined budget.

At block 2008, based on the comparison, a determination is made whether the one or more cost values meet or exceed at least one of the preset threshold percentages.

At block 2010, in a case where the one or more cost values meet or exceed at least one of the preset threshold percentages, a notification is generated for a first user who bills against the predefined budget and for a second user who supervises the predefined budget. The notification indicates which of the preset threshold percentages are met or exceeded by the one or more cost values.

The first user can be a timekeeper associated with the predefined budget. Alternatively or in addition, the first user can be a vendor associated with providing resources in association with the predefined budget.

At block 2012, the generated notification is provided to the first user and to the second user. The generated notification can be provided to the first user and to the second user as an electronic message.

A tracking interface can be provided for display, the tracking interface including a summary of finances associated with the predefined budget and costs applied to the predefined budget, the costs applied to the predefined budget comprising the one or more cost values. The tracking interface can further include a history of notifications generated in association with the costs applied to the predefined budget.

A hold on the predefined budget can be initiated, based on a determination that the one or more cost values meets or exceeds an entirety of the predefined budget. Initiating the hold on the predefined budget can include prohibiting subsequent costs to be applied to the predefined budget. The subsequent costs can include timekeeper costs, and prohibiting subsequent costs can include prohibiting the timekeeper costs from being entered within a time entry system until authorized by the supervisor.

The predefined budget can correspond to a service including multiple tasks, and the receiving comparing, determining, generating and providing can be performed for one or more of the multiple tasks, on a per-task basis. The process then ends at end block 2014.

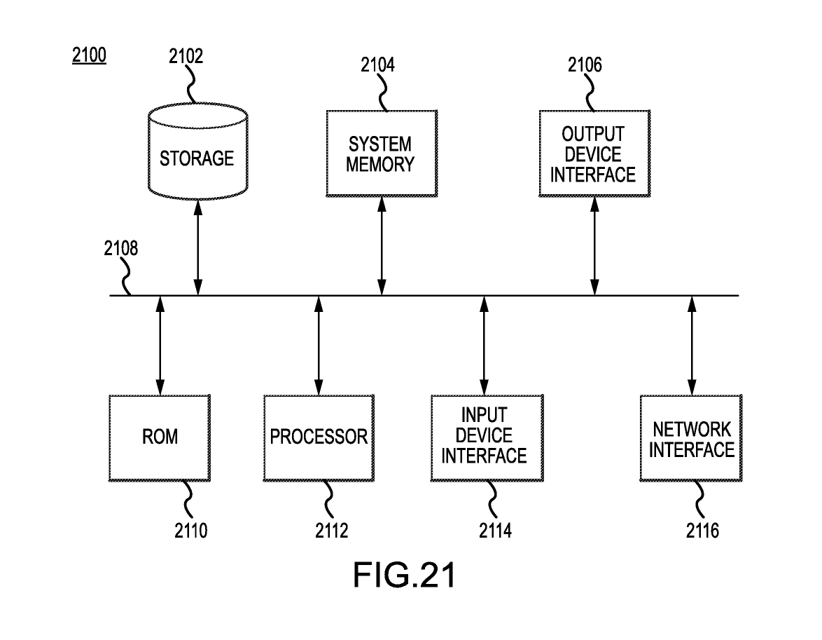

FIG. 21 conceptually illustrates an example electronic system with which some implementations of the subject technology can be implemented. Electronic system 2100 can be a computer, phone, PDA, or any other sort of electronic device. Such an electronic system includes various types of computer readable media and interfaces for various other types of computer readable media. Electronic system 2100 includes a bus 2108, processing unit(s) 2112, a system memory 2104, a read-only memory (ROM) 2110, a permanent storage device 2102, an input device interface 2114, an output device interface 2106, and a network interface 2116.

Bus 2108 collectively represents all system, peripheral, and chipset buses that communicatively connect the numerous internal devices of electronic system 2100. For instance, bus 2108 communicatively connects processing unit(s) 2112 with ROM 2110, system memory 2104, and permanent storage device 2102.

From these various memory units, processing unit(s) 2112 retrieves instructions to execute and data to process in order to execute the processes of the subject disclosure. The processing unit(s) can be a single processor or a multi-core processor in different implementations.

ROM 2110 stores static data and instructions that are needed by processing unit(s) 2112 and other modules of the electronic system. Permanent storage device 2102, on the other hand, is a read-and-write memory device. This device is a non-volatile memory unit that stores instructions and data even when electronic system 2100 is off. Some implementations of the subject disclosure use a mass-storage device (for example, a magnetic or optical disk and its corresponding disk drive) as permanent storage device 2102.

Other implementations use a removable storage device (for example, a floppy disk, flash drive, and its corresponding disk drive) as permanent storage device 2102. Like permanent storage device 2102, system memory 2104 is a read-and-write memory device. However, unlike storage device 2102, system memory 2104 is a volatile read-and-write memory, such a random access memory. System memory 2104 stores some of the instructions and data that the processor needs at runtime. In some implementations, the processes of the subject disclosure are stored in system memory 2104, permanent storage device 2102, or ROM 2110. For example, the various memory units include instructions for tracking budgets in accordance with some implementations. From these various memory units, processing unit(s) 2112 retrieves instructions to execute and data to process in order to execute the processes of some implementations.

Bus 2108 also connects to input and output device interfaces 2114 and 2106. Input device interface 2114 enables the user to communicate information and select commands to the electronic system. Input devices used with input device interface 2114 include, for example, alphanumeric keyboards and pointing devices (also called ‘cursor control devices’). Output device interfaces 2106 enables, for example, the display of images generated by the electronic system 2100. Output devices used with output device interface 2106 include, for example, printers and display devices, for example, cathode ray tubes (CRT) or liquid crystal displays (LCD). Some implementations include devices, for example, a touchscreen that functions as both input and output devices.

Finally, as shown in FIG. 21, bus 2108 also couples electronic system 2100 to a network (not shown) through a network interface 2116. In this manner, the computer can be a part of a network of computers (for example, a local area network (‘LAN’), a wide area network (‘WAN’), or an Intranet, or a network of networks, for example, the Internet. Any or all components of electronic system 2100 can be used in conjunction with the subject disclosure.

### Illustration of Subject Technology as Clauses

Various examples of aspects of the disclosure are described as numbered clauses (1, 2, 3, etc.) for convenience. These are provided as examples, and do not limit the subject technology. Identifications of the figures and reference numbers are provided below merely as examples and for illustrative purposes, and the clauses are not limited by those identifications.

1. A method for tracking costs relative to a budget, the method comprising:

receiving one or more cost values for applying against a predefined budget;

comparing the one or more cost values against preset threshold percentages for the predefined budget, each preset threshold percentage indicating a percentage of costs applied against the predefined budget at which to notify users;

determining, based on the comparison, whether the one or more cost values meet or exceed at least one of the preset threshold percentages;

generating, in a case where the one or more cost values meet or exceed at least one of the preset threshold percentages, a notification for a first user who bills against the predefined budget and for a second user who supervises the predefined budget, the notification indicating which of the preset threshold percentages are met or exceeded by the one or more cost values; and

providing the generated notification to the first user and to the second user.

2. The method of clause 1 or any of the clauses, wherein the one or more cost values comprise at least one of timekeeper costs, vendor costs, material costs or costs for other resources.

3. The method of clause 2 or any of the clauses, wherein receiving the cost values for the timekeeper costs comprises tracking the timekeeper costs as they are entered within a time entry method.

4. The method of clause 3 or any of the clauses, wherein the timekeeper costs are entered within the time entry method using time entry codes associated with the predefined budget.

5. The method of clause 1 or any of the clauses, wherein the generated notification is provided to the first user and to the second user as an electronic message.

6. The method of clause 1 or any of the clauses, further comprising: providing a tracking interface for display, the tracking interface including a summary of finances associated with the predefined budget and costs applied to the predefined budget, the costs applied to the predefined budget comprising the one or more cost values.

7. The method of clause 6 or any of the clauses, wherein the tracking interface further includes a history of notifications generated in association with the costs applied to the predefined budget.

8. The method of clause 1 or any of the clauses, further comprising: initiating a hold on the predefined budget, based on a determination that the one or more cost values meets or exceeds an entirety of the predefined budget.

9. The method of clause 8 or any of the clauses, wherein initiating the hold on the predefined budget comprises prohibiting subsequent costs to be applied to the predefined budget.

10. The method of clause 9 or any of the clauses, wherein the subsequent costs comprise timekeeper costs, and wherein prohibiting subsequent costs comprises prohibiting the timekeeper costs from being entered within a time entry method until authorized by the supervisor.

11. The method of clause 1 or any of the clauses, wherein one of the preset threshold percentages corresponds to the entirety of the predefined budget.

12. The method of clause 1 or any of the clauses, wherein the predefined budget corresponds to a service comprising multiple tasks, and wherein the receiving, comparing, determining, generating and providing are performed for one or more of the multiple tasks, on a per-task basis.

13. The method of clause 1 or any of the clauses, wherein the first user is a timekeeper associated with the predefined budget.

14. The method of clause 1 or any of the clauses, wherein the first user is a vendor associated with providing resources in association with the predefined budget.

15. A processor configured for tracking costs relative to a budget, comprising modules for carrying out the method of any of clauses 1-14.

16. A machine-readable storage medium comprising code for causing a computing machine to carry out the method of any of clauses 1-14.

17. An apparatus, comprising means for carrying out the method of any of clauses 1-14.

18. An apparatus, comprising components operable to carry out the method of any of clauses 1-14.

19. A system comprising:

one or more processors; and

a machine-readable medium comprising instructions stored therein, which when executed by the processors, cause the processors to perform the method of any of clauses 1-14.

### Other Remarks

In one aspect, any of the clauses herein may depend from any one of the independent clauses or any one of the dependent clauses. In one aspect, any of the clauses (e.g., dependent or independent clauses) may be combined with any other one or more clauses (e.g., dependent or independent clauses). In one aspect, a claim may include some or all of the words (e.g., steps, operations, means or components) recited in a clause, a sentence, a phrase or a paragraph. In one aspect, a claim may include some or all of the words recited in one or more clauses, sentences, phrases or paragraphs. In one aspect, some of the words in each of the clauses, sentences, phrases or paragraphs may be removed. In one aspect, additional words or elements may be added to a clause, a sentence, a phrase or a paragraph. In one aspect, the subject technology may be implemented without utilizing some of the components, elements, functions or operations described herein. In one aspect, the subject technology may be implemented utilizing additional components, elements, functions or operations.

In one aspect, any methods, instructions, code, means, logic, components, blocks, modules and the like (e.g., software or hardware) described or claimed herein can be represented in drawings (e.g., flow charts, block diagrams), such drawings (regardless of whether explicitly shown or not) are expressly incorporated herein by reference, and such drawings (if not yet explicitly shown) can be added to the disclosure without constituting new matter. For brevity, some (but not necessarily all) of the clauses/descriptions/claims are explicitly represented in drawings, but any of the clauses/descriptions/claims can be represented in drawings in a manner similar to those drawings explicitly shown. For example, a flow chart can be drawn for any of the clauses, sentences or claims for a method such that each operation or step is connected to the next operation or step by an arrow. In another example, a block diagram can be drawn for any of the clauses, sentences or claims having means-for elements (e.g., means for performing an action) such that each means-for element can be represented as a module for element (e.g., a module for performing an action).

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term ‘software’ is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example, microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example, is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself.

As used in this specification, the terms ‘computer’, ‘server’, ‘processor’, and ‘memory’ all refer to electronic or other technological devices. These terms exclude people or groups of people. For the purposes of the specification, the terms display or displaying means displaying on an electronic device. As used in this specification, the terms ‘computer readable medium’ and ‘computer readable media’ are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (‘LAN’) and a wide area network (‘WAN’), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Reference to an element in the singular is not intended to mean ‘one and only one’ unless specifically so stated, but rather ‘one or more.’ Unless specifically stated otherwise, the term ‘some’ refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an ‘aspect’ does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a ‘configuration’ does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

What is claimed is:

1. A system for tracking costs relative to a budget, the system comprising:
one or more processors; and
a machine-readable medium comprising instructions stored therein, which when executed by the processors, cause the processors to perform operations comprising:
receiving one or more cost values for applying against a predefined budget;
comparing the one or more cost values against preset threshold percentages for the predefined budget, each preset threshold percentage indicating a percentage of costs applied against the predefined budget at which to notify users;
determining, based on the comparison, whether the one or more cost values meet or exceed at least one of the preset threshold percentages;
generating, in a case where the one or more cost values meet or exceed at least one of the preset threshold percentages, a notification for a first user who bills against the predefined budget and for a second user who supervises the predefined budget, the notification indicating which of the preset threshold percentages are met or exceeded by the one or more cost values; and
providing the generated notification to the first user and to the second user.

2. The system of claim 1, wherein the one or more cost values comprise at least one of timekeeper costs, vendor costs, material costs or costs for other resources.

3. The system of claim 2, wherein receiving the cost values for the timekeeper costs comprises tracking the timekeeper costs as they are entered within a time entry system.

4. The system of claim 3, wherein the timekeeper costs are entered within the time entry system using time entry codes associated with the predefined budget.

5. The system of claim 1, wherein the generated notification is provided to the first user and to the second user as an electronic message.

6. The system of claim 1, the operations further comprising:
providing a tracking interface for display, the tracking interface including a summary of finances associated with the predefined budget and costs applied to the predefined budget, the costs applied to the predefined budget comprising the one or more cost values.

7. The system of claim 6, wherein the tracking interface further includes a history of notifications generated in association with the costs applied to the predefined budget.

8. The system of claim 1, the operations further comprising:
initiating a hold on the predefined budget, based on a determination that the one or more cost values meets or exceeds an entirety of the predefined budget.

9. The system of claim 8, wherein initiating the hold on the predefined budget comprises prohibiting subsequent costs to be applied to the predefined budget.

10. The system of claim 9, wherein the subsequent costs comprise timekeeper costs, and wherein prohibiting subsequent costs comprises prohibiting the timekeeper costs from being entered within a time entry system until authorized by the supervisor.

11. The system of claim 1, wherein one of the preset threshold percentages corresponds to the entirety of the predefined budget.

12. The system of claim 1, wherein the predefined budget corresponds to a service comprising multiple tasks, and wherein the receiving, comparing, determining, generating and providing are performed for one or more of the multiple tasks, on a per-task basis.

13. The system of claim 1, wherein the first user is a timekeeper associated with performing the predefined budget.

14. The system of claim 1, wherein the first user is a vendor associated with providing resources in association with the predefined budget.

15. A machine-readable medium comprising instructions stored therein, which when executed by a machine, cause the machine to perform operations comprising:
receiving one or more cost values for applying against a predefined budget;
comparing the one or more cost values against preset threshold percentages for the predefined budget, each preset threshold percentage indicating a percentage of costs applied against the predefined budget at which to notify users;
determining, based on the comparison, whether the one or more cost values meet or exceed at least one of the preset threshold percentages;
generating, in a case where the one or more cost values meet or exceed at least one of the preset threshold percentages, a notification for a first user who bills against the predefined budget and for a second user who supervises the predefined budget, the notification indicating which of the preset threshold percentages are met or exceeded by the one or more cost values; and
providing the generated notification to the first user and to the second user.

16. The machine-readable medium of claim 15, wherein the one or more cost values comprise at least one of timekeeper costs, vendor costs, material costs or costs for other resources.

17. The machine-readable medium of claim 16, wherein receiving the cost values for the timekeeper costs comprises tracking the timekeeper costs as they are entered within a time entry system.

18. The machine-readable medium of claim 17, wherein the timekeeper costs are entered within the time entry system using time entry codes associated with the predefined budget.

19. The machine-readable medium of claim 15, wherein the threshold amount is a predefined percentage of the predefined budget.

20. A method for tracking costs relative to a budget, the method comprising:
receiving one or more cost values for applying against a predefined budget;
comparing the one or more cost values against preset threshold percentages for the predefined budget, each preset threshold percentage indicating a percentage of costs applied against the predefined budget at which to notify users;
determining, based on the comparison, whether the one or more cost values meet or exceed at least one of the preset threshold percentages;
generating, in a case where the one or more cost values meet or exceed at least one of the preset threshold percentages, a notification for a first user who bills against the predefined budget and for a second user who supervises the predefined budget, the notification indicating which of the preset threshold percentages are met or exceeded by the one or more cost values; and
providing the generated notification to the first user and to the second user.
